(19) United States
(12) Patent Application Publication
(10) Pub. No.: US 2018/0021996 A1
(43) Pub. Date: Jan. 25, 2018

(54) Marbled Grip

(71) Applicant: Eaton Corporation, Cleveland, OH (US)

(72) Inventor: Alex Lee Walls, Laurinburg, NC (US)

(21) Appl. No.: 15/597,182

(22) Filed: May 17, 2017

Related U.S. Application Data
(60) Provisional application No. 62/363,878, filed on Jul. 19, 2016.

(51) Int. Cl. B29C 45/14; B29C 45/26

(52) U.S. Cl. CPC B29C 45/14622; B29C 45/14065; B29C 45/261; B29K 2995/002; B29L 2031/463

(57) ABSTRACT

A unique grip and a method for making a unique grip with a marbled appearance includes a dual molding process including the steps of compression molding and injection molding simultaneously to form the grip with a marbled appearance.

### CROSS-REFERENCE TO RELATED APPLICATIONS

This application claims priority to U.S. Provisional Patent Application 62/363,878 filed Jul. 19, 2016 in the name of Alex Lee Walls for a “Marbled Grip”, which is incorporated by reference herein in its entirety.

### FIELD

The present disclosure relates in general to a new grip, and more particularly to a new grip for sporting implements having a marbled appearance and a method for making the same.

### BACKGROUND

Grips are widely used on many items ranging from tools to sporting implements like golf, tennis, squash, racquetball, or fishing rod to name a few. Hand grips are also used on motorized sporting implements or machines like bicycles, motorcycles, or personal watercrafts. The term “sporting implements” as used herein is broadly used and meant to include any application requiring a grip that slides on to a shaft, rod, or handle. The term “shaft” as used herein is meant to include a shaft, rod, or handle. The appearance of the grip on these types of sporting implements have become increasingly important since many of these sporting events are social in nature and the appearance of the grip is a reflection of the user. That is the players often are looking for a hand grip with a style or appearance that stands out from the crowd and in some cases may be a reflection of themselves, or in other cases to simply set a new style, or even match the implement they are using.

There still exists a need for a new grip having a unique appearance. Such a grip provides a distinctive character for the sports implement and provides a unique one-of-a kind appearance.

### BRIEF SUMMARY OF THE DISCLOSURE

The present disclosure is directed to a new grip with an improved appearance.

The present disclosure is also directed to a dual molding process for creating a hand grip with an unique appearance, comprising the steps of providing a dual mold for molding a grip; positioning selected pieces of at least one material of different sizes at different locations within a cavity of the mold; closing the mold; injecting a second liquid material into the mold for filling the cavity of the mold; and forming a grip having a unique appearance.

The various features of novelty which characterize the present disclosure are pointed out with particularity in the claims annexed to and forming a part of this disclosure. For a better understanding and its operating advantages attained with its use, reference is made to the accompanying drawings, and descriptive matter.

### BRIEF DESCRIPTION OF THE DRAWINGS

FIG. 1 is a sectional view of a golf club grip on a shaft;

FIG. 2 is a frontal view of an open mold suited for use with the present disclosure;

FIG. 3 is top view of the upper injection mold sprue plate with runners and sprues depicted;

FIG. 4 is a partial sectional bottom view depicting one upper mold cavity with the injection sprue;

FIG. 5 is a flow diagram setting forth the steps of the method according to the present disclosure ; and

FIG. 6 is a frontal view of golf grips made according to the present disclosure illustrating the unique marbled appearance of each grip formed.

### DETAILED DESCRIPTION

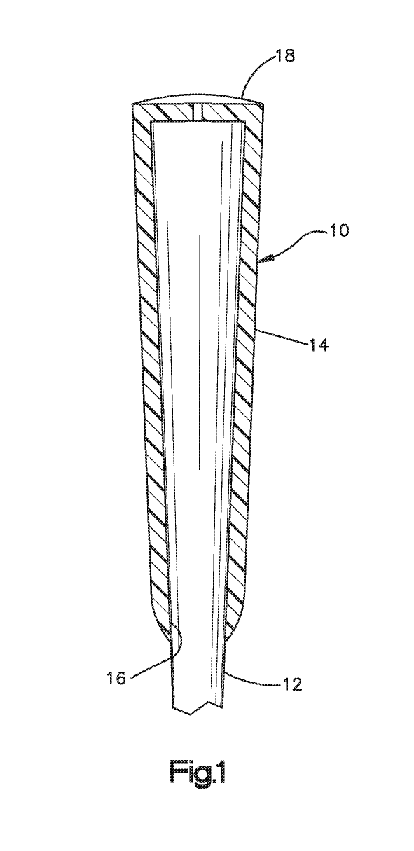

Referring to the figures, which are not intended to limit the present disclosure and where like numerals designate like or similar features throughout the several views, and first in particular to FIG. 1, there is shown in sectional view a grip 10 positioned on a shaft 12. Grip 10 is the type that is constructed to slide on to a shaft and be retained thereon. Grip 10 is typically an elongated hollow tubular body 14 made from a rubber or rubber like material with an open end 16 sized to slip on to the shaft and a butt end 18 at an opposite end of the body fitted for the end of the shaft. Specific reference in this disclosure is being made to a golf grip, but it should be understood that the methodology and principles of the present disclosure apply to any type of grip for a sporting implement that is constructed to slip on to a shaft. As mentioned briefly earlier, rubber or rubber like materials such as other elastomeric polymers, like a thermoset material, a thermoplastic rubber (“TPR”) material, or thermoplastic elastomer (“TPE”) material may be used to form the grip 10.

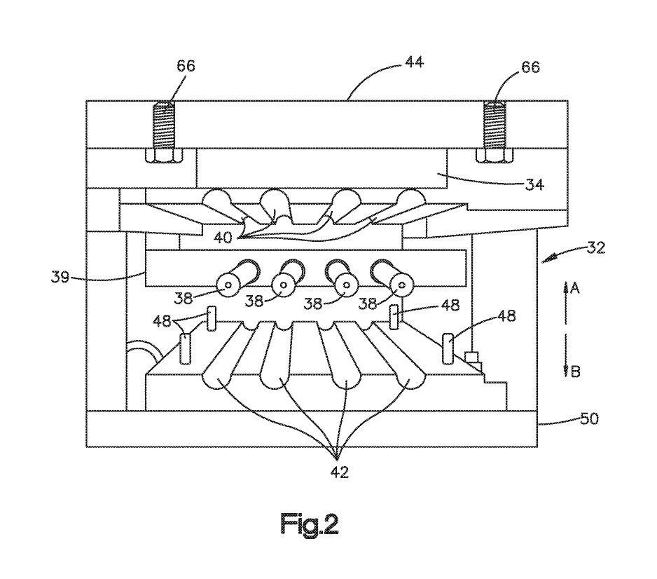

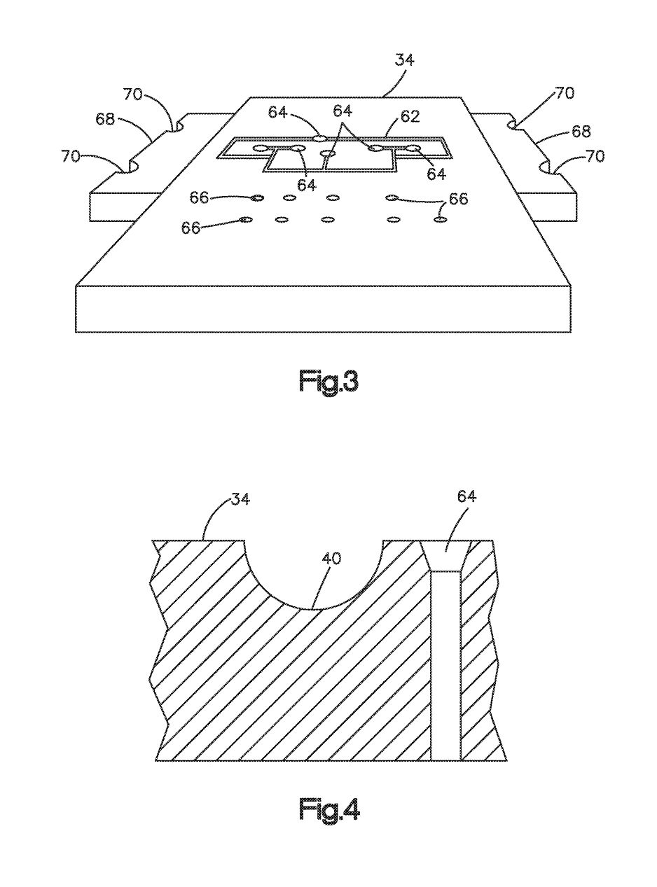

Referring next to FIG. 2, there is shown one embodiment of a dual mold 32 suitable for manufacturing a grip 10 according to the present disclosure. This dual mold is a commercially available injection press mold. Mold 32, also referred to herein as a dual mold, has the structure and functionality of handling a co-molding process, compression and injection molding, as will be described in far greater detail later herein. Mold 32 includes a clamp type compression style mold having two pieces, an upper injection mold sprue plate or section 34, as seen in FIG. 3, a lower mold section or plate 36, and one or more core bars or mandrels 38 fairly centrally located therein as seen in FIG. 2 that are mounted together on a support 39. Mold 32 may include an integral heater (not shown) or alternatively be heated externally in a known manner. Other suitable methods for heating the mold may be employed for heating, vulcanizing, and curing the materials in the mold in manufacturing the final form of the grip. The upper mold injection sprue plate 34 is connected with an electrically heated platen system (not shown) for supplying suitable conditions for injecting rubber or rubber like material.

The upper and lower mold sections 34, 36 include upper and lower mold cavities 40, 42 respectively in confronting surfaces of the upper and lower mold cavities 40, 42 in a form that shapes the grip in the desired form upon completion of the molding process. Each of the mold cavities 40, 42 are closed at one end and have an open end situated axially at a desired distance opposite the closed end. The core bars 38 form the inner diameter of the grip during the molding process and seal off the open end. The desired distance is the desired axial length of the grip to be formed which will vary upon application. For illustrative purposes only, the axial length of a typical golf swing grip is approximately 27 centimeters.

The mold cavities 40, 42 may include a pattern or design or other indicia (not shown) formed by machining grooves or lines or figures into the mold cavity walls, or providing raised portions in the mold cavity walls for making the corresponding design in the outer surface of the grip. These designs may be for aesthetic purposes or for providing grip handling or grip feel attributes.

The mold 32 may contain a manual or automated actuated press 44 that operates to open the mold 32 as indicated by the arrow A in the up or open position, and then down in the direction of arrow B when the press closes the mold 32 completely. Alignment pins 48 constructed to be received in openings (not shown) facilitate proper alignment of the upper and lower mold sections 34, 36 when the mold is compressed closed for compression molding. Core bar support 39 with the core bars 38 are moved into proper position and alignment within the mold 32 during the actuation of the press 44. Mold 32 may be positioned on a support table 50 for supporting one or more molds 32. FIG. 3 depicts the upper mold section 34 also referred to herein as the injection mold sprue plate 34 with its runners 62 and sprues 64 depicted. The runners 62 are the channels that the liquid rubber or rubber like material flow through during the injection process. The sprues 64 are the nozzles and passages that fill the cavities of mold 32. Upper injection mold sprue plate 34 includes brackets 68 with grooves 70 for mounting with fasteners 66 to the press 44. The sprues 64 are in fluid communication with each of the upper mold 40 cavities, as best seen in FIG. 4, for the transfer of a molten elastomer, rubber, or rubber like material under high pressure into the cavities of the mold 32 to achieve simultaneous compression and injection molding of the grip 10.

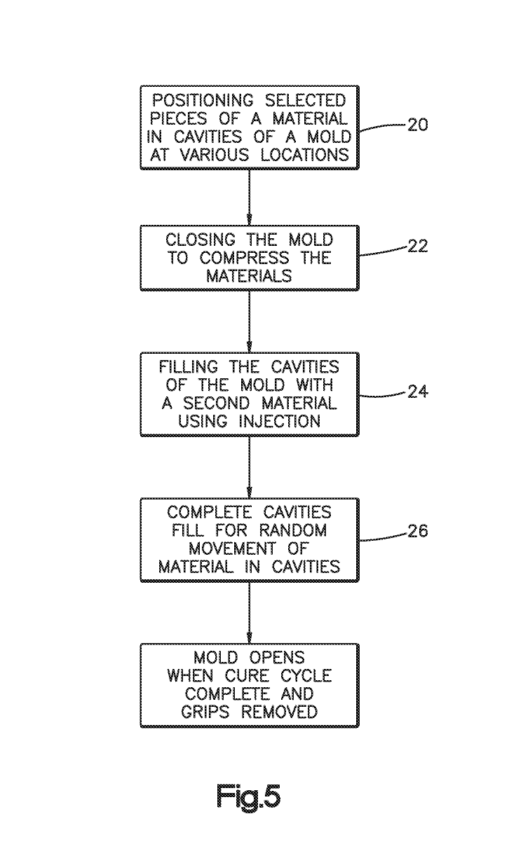

Next referring to FIG. 5, the methodology of the subject disclosure utilized to create a grip with a unique appearance is described in greater detail. The first step in the process as represented by step 1 in block 20 is to position selected random sized pieces, preferably the pieces of material are different sizes having different areas and/or shapes, and/or thickness of a first rubber or rubber like material (more than one type of material with different colors may be used for this step) within various positions in the upper and lower mold cavities 40, 42, and/or onto the top of core bars 38 in the mold, as previously described or one that is capable of compression molding and injection molding simultaneously. Random sizes of pieces of at least one material, pieces from more than one material may be used, that may have one or more colors may be selectively placed in locations of the upper and lower mold cavities 40, 42, or on the core bar 38, or they may be placed randomly in the upper and lower mold cavities 40, 42, and/or on the core bar 38. For illustrative purposes only, a fiber reinforced material may be desirable in the upper portion of the grip so the pieces of the first material that has a fiber reinforcement would be selectively placed at that location in the lower and upper mold cavities. If one desires a more marbled area to a specific location on the grip, for example, on the upper portion of the grip or alternatively on the lower portion of the grip, one would place the pieces in the desired area in the upper and lower mold cavities.

Next, the mold 32 is closed in step 2 of the process as represented by block 22. Step 3 of this process fills the cavities of the mold 32 with a second rubber or rubber like material using an injection molding process as represented by block 24. Then, in step 4 the cavities are completely filled to cause random movement of the materials within the cavities as represented by block 26. The mold 32 is heated to a temperature sufficient for liquefying the rubber or rubber like first material, and then subsequently curing the formal grip at the cure temperature and cure time, and then opens when the cure cycle is complete and the finished grips 10 removed. The second material may be a blend of rubber or rubber like materials with fibers if desired. The compression molding process and injection molding process are conducted simultaneously for forming a grip with a unique marbled appearance. The injection process parameters of pressures and speeds may be adjusted to create different appearances and effects. This process allows each grip to be uniquely formed with a marbled random appearance. Materials utilized to produce the grip must be compatible as thermosets or TPR type materials based on processing methods or equipment types.

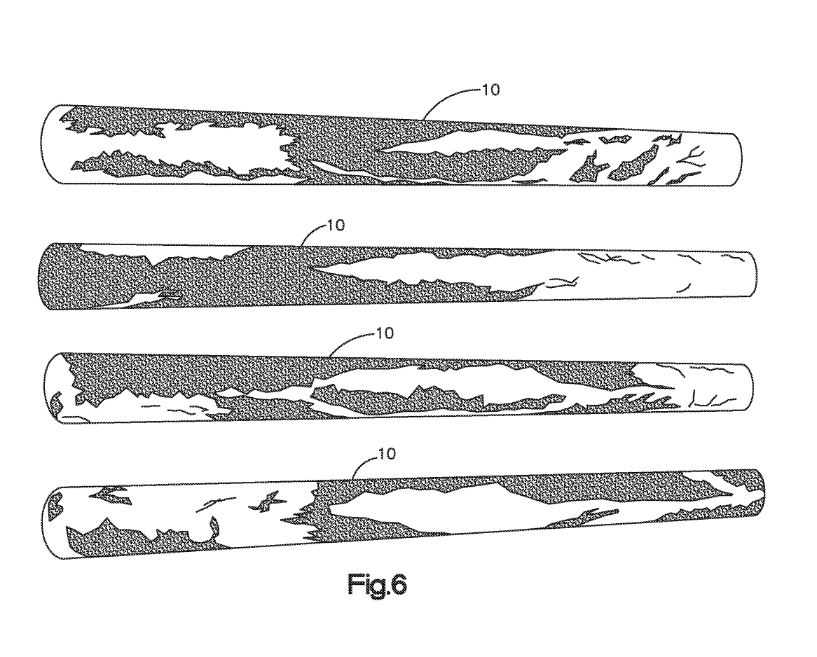

FIG. 6 shows in a perspective view golf grips 10 made in accordance with the present disclosure depicting the uniqueness of each grip with its own marbled appearance.

Equipment settings can vary in the following ways to impact the marbled appearance. Temperature settings may range from 160 to 175 degrees Celsius. Injection pressure can be adjusted based on machine types and pressure ranges. For illustrative purposes only, the equipment used is rated at 150 tons of clamp pressure and has injection pressure settings that can range from 1350 to 2275 pounds per square inch (“psi”) (160 kilograms/square centimeter). Other parameters that will impart the marbled appearances include delay of injection process and mold close delay.

While specific embodiments of the invention have been shown and described in detail to illustrate the application of the principles of the disclosure, it will be understood that the disclosure may be embodied otherwise without departing from such principles.

I claim:

1. A dual molding process for making a unique grip with a marbled appearance, comprises the steps of:
providing a mold for molding a grip;
positioning selected pieces of at least one material of different sizes at different locations within at least one cavity of the mold;
closing the mold;
filling the at least one cavity with a second material using an injection molding process while compression molding the grip simultaneously;
completely filling the at least one cavity of the mold for causing random movement of both materials within the at least one cavity; and
opening the mold when a curing cycle is completed for removal of the grip.

2. A dual molding process as recited in claim 1, wherein the at least one material comprises a color different from the second material.

3. A dual molding process as recited in claim 2, wherein the positioning step includes randomly positioning the selected pieces in the at least one cavity of the mold.

4. A dual molding process as recited in claim 1, wherein the grip is a golf grip.

5. A golf grip formed according to the process of claim 1 having a marbled appearance.
